(19) United States
(12) Patent Application Publication
(10) Pub. No.: US 2026/0204051 A1
(43) Pub. Date: Jul. 16, 2026

(54) Method and Apparatus for Integrating Classification, Localization, and Segmentation Through Lock-Release Pretraining Strategy for Chest X-Ray Analysis

(71) Applicants: Nahid UI ISLAM, Mesa, AZ (US); DongAo MA, Tempe, AZ (US); Jiaxuan PANG, Tempe, AZ (US); Jianming LIANG, Scottsdale, AZ (US)

(72) Inventors: Nahid UI ISLAM, Mesa, AZ (US); DongAo MA, Tempe, AZ (US); Jiaxuan PANG, Tempe, AZ (US); Jianming LIANG, Scottsdale, AZ (US)

(73) Assignee: Arizona Board of Regents on Behalf of Arizona State University, Scottsdale, AZ (US)

(21) Appl. No.: 19/447,985

(22) Filed: Jan. 13, 2026

Related U.S. Application Data
(60) Provisional application No. 63/744,744, filed on Jan. 13, 2025.

(51) Int. Cl. G06V 10/778; G06V 10/26; G06V 10/764

(52) U.S. Cl. CPC G06V 10/778; G06V 10/26; G06V 10/764

(57) ABSTRACT

Computer-implemented method for developing a deep learning model, comprising receiving a plurality of image datasets each including one or more of a plurality of inconsistent or heterogeneous annotations across a corresponding one or more of a plurality of tasks including classification, localization, and segmentation tasks employed in imaging; and training, with the plurality of image datasets, the learning model to retain general knowledge across all of the plurality of tasks while preventing overfitting to any one of the plurality of tasks, using an end-to-end framework comprising a student-teacher model, a shared backbone, a classification task branch, a localization task branch, and a segmentation task branch, the framework integrating and concurrently performing the plurality of tasks on the plurality of image datasets, including implementing a lock-release pretraining strategy that involves cyclically training the learning model using the plurality of image datasets and sequentially processing each of the plurality of image datasets.

### CLAIM OF PRIORITY

This application claims the benefit of U.S. Provisional Patent Application No. 63/744,744, filed Jan. 13, 2025, entitled “INTEGRATING CLASSIFICATION, LOCALIZATION, AND SEGMENTATION THROUGH LOCK-RELEASE PRETRAINING STRATEGY FOR CHEST X-RAY ANALYSIS”, the disclosure of which is incorporated by reference herein in its entirety.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

A portion of this document contains material which is subject to copyright protection. The copyright owner has no objection to the facsimile reproduction by anyone of the document as it appears in the Patent and Trademark Office records but otherwise reserves all copyright rights whatsoever.

### TECHNICAL FIELD

Embodiments of the disclosure relate to deep-learning machine learning models and in particular an end-to-end framework that utilizes diverse expert-level annotations from numerous public datasets to train a foundation model capable of multiple tasks including classification, localization, and segmentation.

### BACKGROUND

In computer vision, tasks like classification, localization, and segmentation are often handled independently. This approach can lead to inefficiencies and limit performance in complex, real-world applications. Isolated models miss the opportunity to leverage the rich, diverse information available when these tasks are integrated. In medical imaging, datasets often contain different diseases annotated with image-level labels, disease-specific bounding boxes, and segmentation masks. For example, the CheXpert dataset has only image-level labels for classification, while TBX11K has both image-level labels and bounding boxes, and CANDID-PTX provides annotations for all three tasks. By integrating these types of annotations into a single model, a deeper understanding can be achieved for each dataset. It is hypothesized that combining the tasks of classification to identify diseases, localization to generate bounding boxes, and segmentation to delineate boundaries, within the same framework improves analysis. This, in turn, leads to better diagnostic accuracy and more informed medical decisions. Therefore, developing an end-to-end framework that handles all tasks simultaneously would boost performance and enhance robustness by taking advantage of the semantic relationships between tasks. However, this integration poses a significant challenge, as models tend to overfit to a single task during training, hindering generalization across multiple tasks.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 illustrates an embodiment including an end-to-end machine learning model that integrates classification, localization, and segmentation tasks for medical imaging.

FIGS. 2A, 2B and 2C illustrate performance trends of embodiments of the disclosure across multiple datasets for both focused and unfocused training scenarios.

FIG. 3 graphically illustrates that full finetuning according to the disclosed embodiments outperform both head-only finetuning of embodiments and a baseline Swin-B+DINO model with Ark-6 initialized backbone weights, in which all three settings followed the same hyperparameters as mentioned herein.

FIGS. 4A, 4B and 4C illustrate performance trends of embodiments across multiple datasets for both focused and unfocused training scenarios.

FIG. 5 presents Table 1 which demonstrates the capability of the disclosed embodiments, wherein a model according to the disclosed embodiments is trained on 11 datasets and further fine-tuned on additional target tasks, showcasing the model's potential.

FIG. 6 presents Table 2 which shows differences between Foundation X model configurations, according to the disclosed embodiments.

FIG. 7 presents Table 3 which shows how baseline localization and segmentation tasks are trained separately, whereas the Foundation X-LS model handles both tasks together in pretraining, according to the disclosed embodiments.

FIG. 8 presents Table 4 which provides a performance comparison of Foundation X and Baseline models.

FIG. 9 presents Table 5 which shows notable performance gains over Ark and POPAR, according to the disclosed embodiments.

FIG. 10 presents Table 6 which shows notable performance gains over Ark and POPAR, according to the disclosed embodiments.

FIG. 11 presents Table 7 which shows experiment settings for Foundation X,

according to the disclosed embodiments.

FIG. 12 presents Algorithm 1, according to the disclosed embodiments.

FIG. 13 presents Table 8 which demonstrates a lock-release pretraining strategy using the VinDr-CXR dataset, according to the disclosed embodiments.

FIG. 14 presents Table 9 which shows parameter distribution across key components of the Foundation X model, trained on 11 datasets and 20 tasks, according to the disclosed embodiments.

FIG. 15 presents Table 10 which shows the results of an ablation study, according to the disclosed embodiments.

FIG. 16 presents Table 11 which shows Foundation-X trained on six disease localization tasks, according to the disclosed embodiments.

FIG. 17 presents Table 12 which shows Foundation X-S trained on three disease segmentation datasets, according to the disclosed embodiments.

FIG. 18 presents Table 13 which shows Foundation X-CL trained on six disease datasets, according to the disclosed embodiments.

FIG. 19 presents Table 14 which shows Foundation X-LS trained on six disease localization and three disease segmentation datasets, using the Cyclic and Lock-Release pretraining strategies, according to the disclosed embodiments.

FIG. 20 presents Table 15 which shows Foundation X pretrained on 11 classification datasets, 6 localization datasets, and 3 segmentation datasets, according to the disclosed embodiments.

### DETAILED DESCRIPTION

Developing robust and versatile deep-learning models is essential for enhancing diagnostic accuracy and guiding clinical interventions in medical imaging, but it requires a large amount of annotated data. The advancement of deep learning has facilitated the creation of numerous medical datasets with diverse expert-level annotations. Aggregating these datasets can maximize data utilization and address the inadequacy of labeled data. However, the heterogeneity of expert-level annotations across tasks such as classification, localization, and segmentation presents a significant challenge for learning from these datasets. To this end, embodiments of the disclosure, referred to herein as Foundation X and variants thereof, provide for an end-to-end framework that utilizes diverse expert-level annotations from numerous public datasets to train a foundation model capable of multiple tasks including classification, localization, and segmentation. To address the challenges of annotation and task heterogeneity, the disclosed embodiments use a Lock-Release pretraining strategy to enhance the cyclic learning from multiple datasets, combined with the student-teacher learning paradigm, ensuring the model retains general knowledge for all tasks while preventing overfitting to any single task. To demonstrate the effectiveness of the embodiments, a model was trained using 11 chest X-ray datasets, covering annotations for classification, localization, and segmentation tasks. Experimental results show that the disclosed embodiments achieve notable performance gains through extensive annotation utilization, excel in cross-dataset and cross-task learning, and further enhance performance in organ localization and segmentation tasks.

### I. Introduction

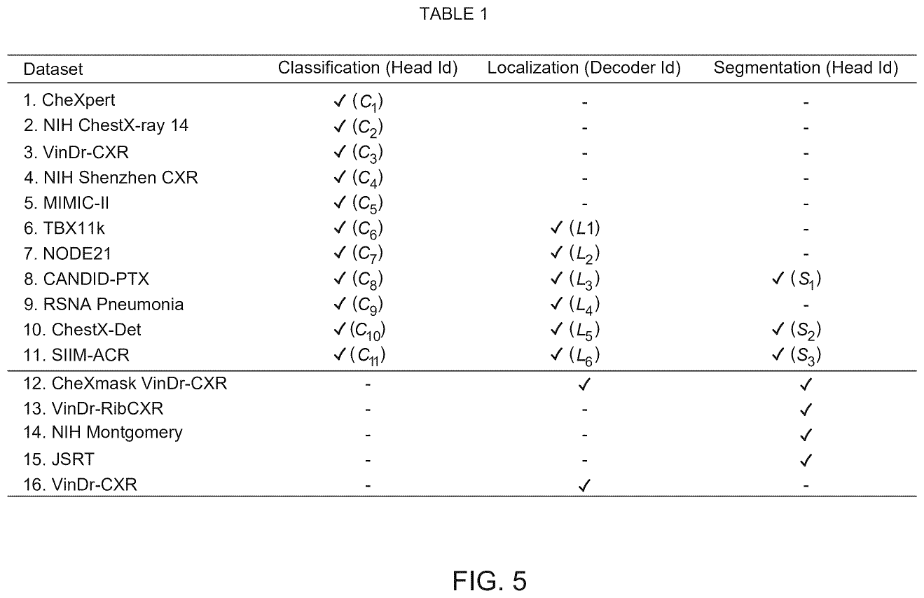

To overcome the above-noted issues in the prior art, embodiments include a framework that tackles classification, localization, and segmentation tasks concurrently and serves as a foundation model. By training it on large-scale, diverse datasets and tasks, the disclosed embodiments build a system capable of handling a broad range of real-world applications, improving both task-specific performance and generalizability. Such a model leverages the synergy between classification, localization, and segmentation tasks, creating a versatile and robust system while maximizing annotation use, reducing costs and enhancing efficiency in medical image analysis. This leads to a central research question: How can one integrate classification, localization, and segmentation tasks within a single model to improve its performance and generalization ability, specifically in Chest X-ray image analysis? Chest X-rays (CXRs) were chosen for research because they are one of the most frequently used imaging modalities, and the availability of CXR data is substantial (see Table 1 presented in FIG. 5).

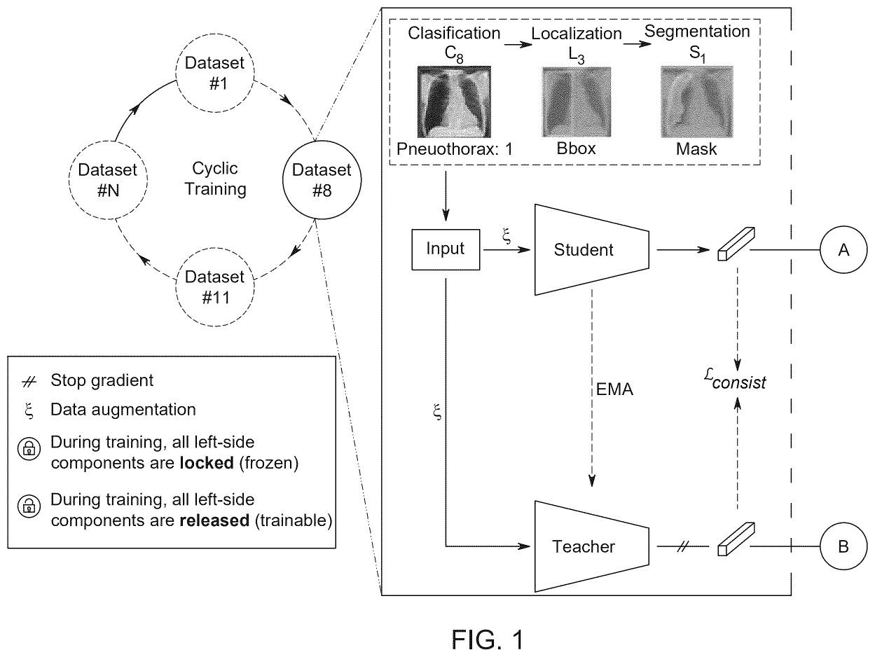

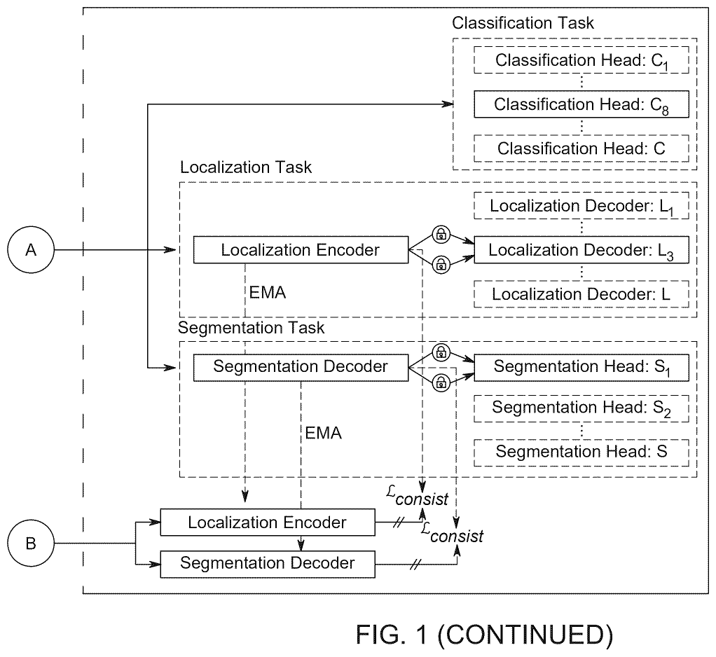

To this extent, the disclosed embodiments provide an end-to-end model that integrates classification, localization, and segmentation tasks for medical imaging, as illustrated in FIG. 1. It is hypothesized that sharing learned representations across tasks equips the model to better capture intricate patterns in medical images, leading to more reliable diagnostics. However, integrating classification, localization, and segmentation into a single model risks overfitting, especially during large-scale training. The disclosed embodiments tackle this by using a shared backbone and innovative pretraining strategies, ensuring balanced performance across diverse tasks. To demonstrate the capability of the embodiments, a model is trained on 11 datasets (Table 1 presented in FIG. 5) and further fine-tuned on additional target tasks, showcasing the model's potential. As shown in Table 1, the Foundation X model is pretrained using 11 publicly available chest X-ray datasets, as shown in the first 11 datasets in the table. Although not every dataset contains all three types of annotations—classification, localization, and segmentation—we leverage all available annotations to maximize the model's learning potential. Among these datasets, all include classification ground truths, 6 provide localization bounding box annotations, and 3 offer segmentation masks for diseases. Furthermore, we utilize organ localization and segmentation datasets from VinDr-CXR, VinDr-RibCXR, NIH Montgomery, and JSRT for target task finetuning. Here, the organ segmentation masks for VinDr-CXR were sourced from the CheXmask database. We also finetuned VinDr-CXR with local labels for disease localization tasks.

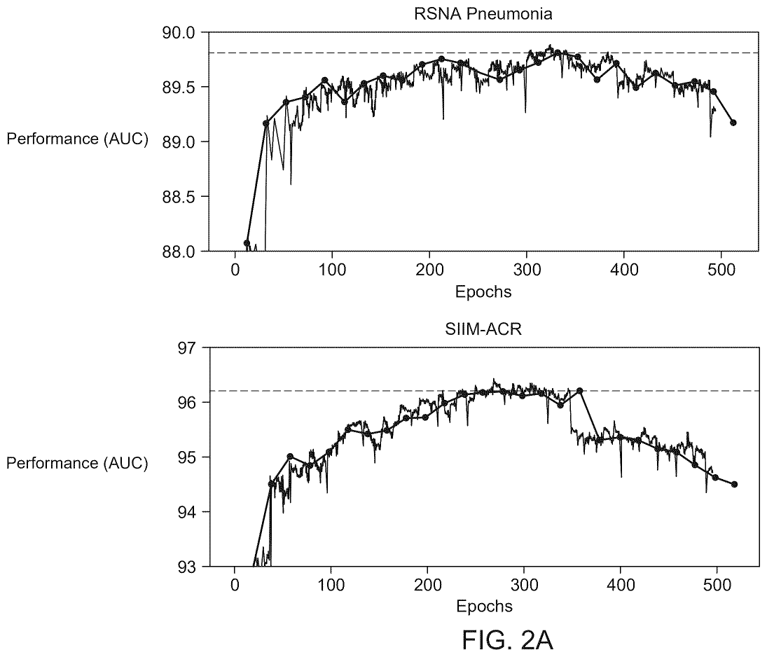

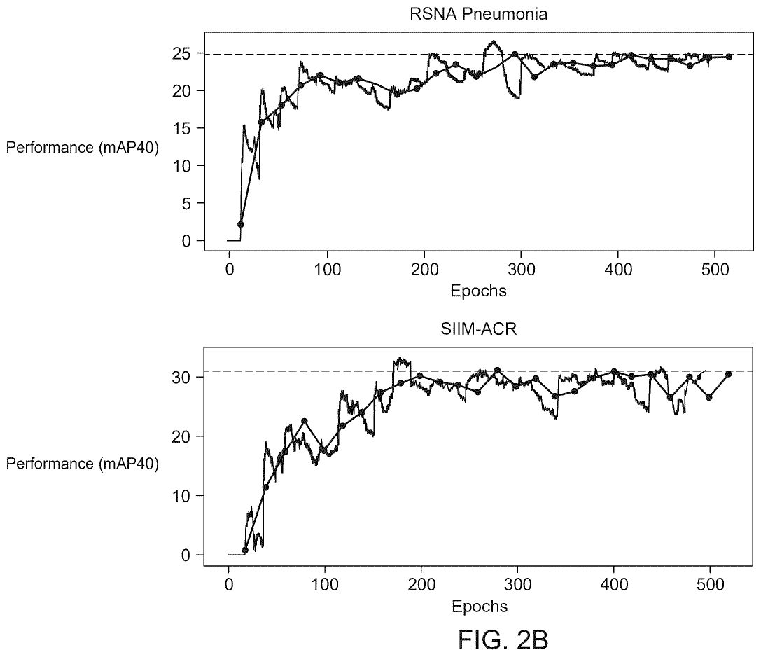

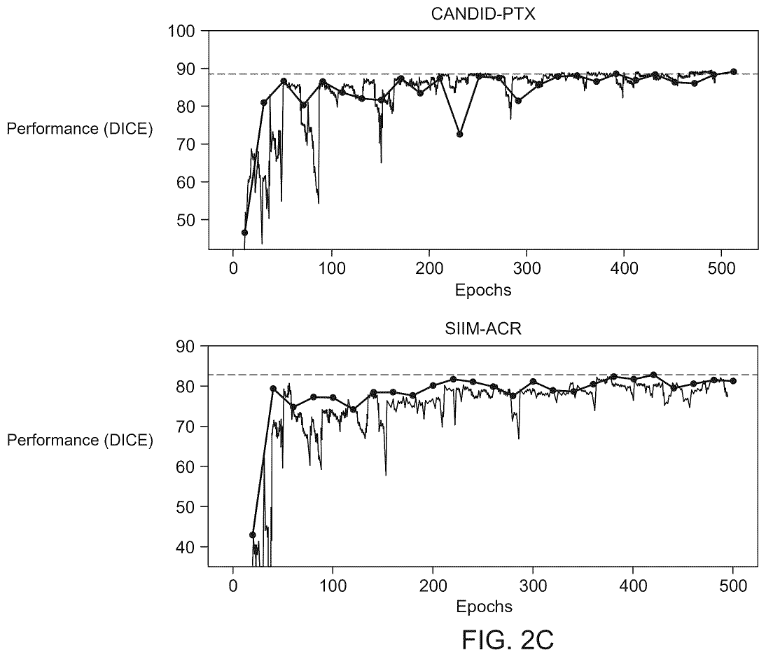

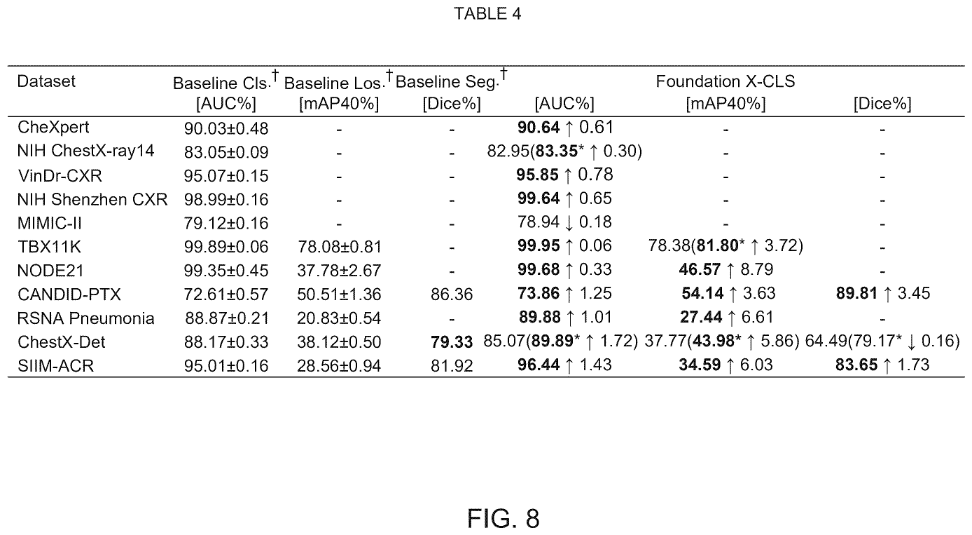

In summary, analysis shows that the disclosed embodiments achieve significant performance gains through extensive annotation usage (Table 4 presented in FIG. 8), excel in cross-dataset and cross-task learning (FIG. 2), and further enhance organ localization and segmentation (Tables 3, 5, 6 respectively presented in FIGS. 7, 9 and 10). Through this work, the following contributions are made:
1. Development and implementation of the embodiments, including an integrated model for classification, localization, and segmentation tasks in Chest X-ray images;
2. A Lock-Release pretraining strategy to enhance the cyclic learning from multiple datasets, preventing task overfitting and ensuring balanced learning across tasks and datasets; and
3. Comprehensive experimental results to demonstrate the embodiments'improved performance and generalization ability.

The disclosed embodiments provide a versatile, end-to-end framework for handling classification, localization, and segmentation tasks in medical imaging. By leveraging shared knowledge across tasks, the disclosed embodiments enhance generalization, reduce overfitting, and maximize annotation use, leading to more efficient data utilization. This approach allows the model to adapt to new tasks and datasets, making it valuable for continuous learning and real-world medical use.

### II. Related Work

Multitask learning mimics the human brain by performing tasks simultaneously with minimal supervision and simplifying cross-learning from different tasks. Significant attention has been given to multitask learning within the research community. In recent years, researchers have focused on utilizing a single backbone with one or more decoders for multitask learning. However, the information shared between these unified or separate decoders was often ineffective, limiting performance and being restricted to either single-task multi-source or single-source multitask objectives. Researchers have explored various approaches to address and improve these learning methods. One approach is OmniFM-DR, which uses the text encoder in parallel with a backbone and along with multiple unified decoders to perform multitask learning. However, the expert annotations are modified to create the input text features for the encoder and the unified multitask decoder architecture. Other learning methods involve using an image backbone and context encoder, then feeding these features into a visual-lingual encoder and decoder. However, these one-stage models use multiple heads for multitask learning, limited to either a text encoder or multiple backbones for the encoder-decoder architecture.

On the other hand, the framework X-Learner consists of two stages: Expansion, where multiple sub-backbones are learned and interconnected to reduce task interference, and Squeeze, where the expanded backbone is condensed into a normal-sized one for effective downstream transfer. However, the multiple sub-backbones may not efficiently capture information between tasks, potentially leading to suboptimal performance on some tasks. Additionally, the lack of an open code-base limits opportunities for comparative studies and comprehensive evaluations.

For techniques to aggregate dataset annotations, Universal Object Detection with Large Vision Model proposes to modify the existing hierarchy of the dataset labels to create a unified label space and incorporate a hierarchical loss suppression technique to efficiently calculate losses for the taxonomies in the labels. The disclosed embodiments'framework differs by aggregating multiple datasets without any modifications to the label taxonomies or the classes themselves using multiple task-heads. Each task-head in the disclosed embodiments is used for a single dataset and vision task.

The work, ViM (Vision Middleware for Unified Downstream Transferring), takes on accommodating multiple different tasks in a single model by introducing a new paradigm. The design involves using a fully frozen backbone pretrained on a large dataset for an upstream task. It then combines various ViM modules (adapters) trained on datasets such as COCO, Objects365, and others, to finally finetune on the target downstream dataset. The disclosed embodiments contrast by having a simpler but effective architecture that inherently learns generalizable representations from multiple datasets and tasks.

Foundation Ark first introduced the idea of accruing and reusing knowledge embedded in the expert annotations from numerous datasets cyclically, but it focused solely on the classification task. In contrast, the disclosed embodiments focus on encompassing diverse tasks, including classification, localization, and segmentation, via a Lock-Release strategy.

### III. Method

### 3.1. Foundation X: Integrating Classification, Localization and Segmentation

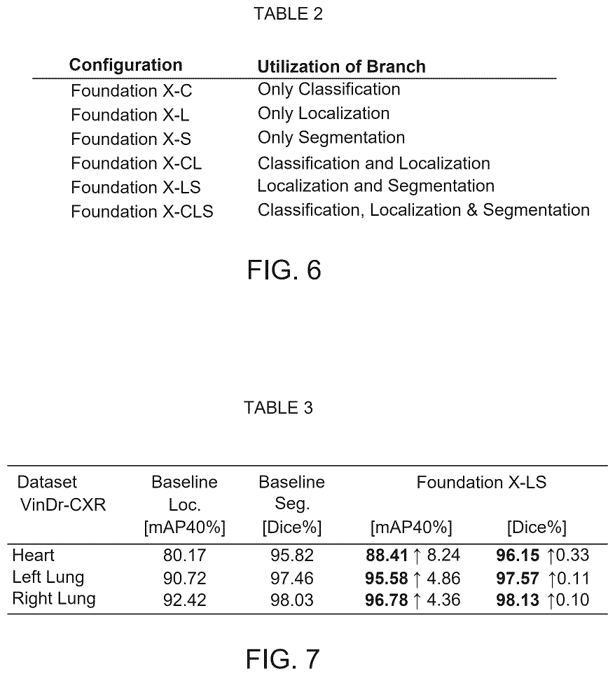

With reference to FIG. 1 and Table 2 presented in FIG. 6, the disclosed embodiments use multiple datasets (Dataset #1 to #11) for pretraining and can also incorporate additional datasets (Dataset #N) dynamically into the pretraining process. The model is trained cyclically, processing each dataset sequentially. Each dataset may include one, two, or all three tasks: classification, localization, and segmentation. FIG. 1 illustrates the process with a dataset (e.g., 8. CANDID-PTX) containing all three types of ground truths. The process begins with the student model (Swin-B) extracting relevant features from the input dataset, which are then directed sequentially to the appropriate branch. First, for classification, features are processed through the classification head (C8). Second, for localization, features pass through the localization encoder and corresponding localization decoder (L3). Third, for segmentation, features are handled by the segmentation decoder and segmentation head (S1). The model undergoes two-phase training for each task: lock mode with most layers frozen, followed by release mode with all layers trainable. Additionally, the model uses a student-teacher learning paradigm. The teacher model, an identical copy of the student model, is updated after each epoch using an exponential moving average (EMA). A consistency loss (L_{const}) is calculated in three areas: extracted features from the backbone, features from the localization encoder, and features from the segmentation decoder. If a dataset contains only one or two types of ground truths, the model will skip the branch without the corresponding ground truth. The disclosed embodiments use the Cyclic and Lock-Release pretraining strategies to enhance performance across tasks while preventing forgetting and avoiding task-specific overfitting.

As shown in FIG. 1, the backbone of the disclosed embodiments (also herein referred to as Foundation X or variants thereof) serve as a knowledge encoder, extracting common features for various tasks performed by three branches: the classification branch with multiple heads, the localization branch with an encoder and multiple decoders, and the segmentation branch with a decoder and multiple heads. Each head or localization decoder corresponds to a specific dataset, as listed in Table 1 presented in FIG. 5. For the classification branch, a classification head is implemented with a linear classifier. For the localization branch, a localization encoder and decoder from DINO (DETR with Improved deNoising anchOr boxes) is used, with modifications to accommodate multiple datasets by using multiple localization decoders. This design ensures that each localization dataset has a dedicated decoder, allowing the model to effectively handle multiple tasks. For the segmentation branch, an UperNet decoder is used and multiple segmentation heads are added atop it to handle different segmentation datasets. The design of multiple heads and localization decoders enhances the flexibility of the disclosed embodiments to allow for seamlessly adding new tasks and making it scalable for task expansion.

### 3.2 Cyclic Pretraining Strategy

Training a single model using diverse datasets with inconsistent or heterogeneous annotations is challenging. The model must learn from various types of information and integrate them into a cohesive understanding. For example, the model needs to extract high-level representations of the entire image for classification, identify specific regions of interest for localization, and delineate the precise boundaries of these regions for segmentation. Even for the same type of task, datasets created at different institutions tend to be annotated differently, further complicating the learning process.

To address these challenges, the disclosed embodiments employ the Cyclic pretraining strategy from Foundation Ark. This strategy enables the model to learn from multiple tasks by revisiting each one in every training round, thereby reinforcing the learning process and preventing the model from forgetting previously acquired knowledge. Benefiting from the Cyclic pretraining, the disclosed embodiments avoid the issue of catastrophic forgetting, where performance on earlier tasks significantly degrades when new tasks are introduced. This approach enables the model to achieve more robust and generalized performance, enhancing its effectiveness across multiple datasets and tasks.

### 3.3 Lock-Release Pretraining Strategy

Another challenge when training a model on diverse datasets and tasks is ensuring it maintains good generalizability across all, without overfitting towards any single dataset or task. The model must be capable of learning from various tasks, understanding heterogeneous annotations, and integrating sophisticated domain knowledge into a cohesive framework that performs well across different tasks. However, due to the varying number of training samples and the differing difficulty levels of each task, the model's learning speed can vary.

To balance the learning process for each task, a Lock-Release pretraining strategy is used for localization and segmentation tasks. Initially, the model is trained in the lock mode, where most early layers are frozen and only a few upper layers are trainable. Specifically, for localization and segmentation tasks, only the localization decoder and segmentation head are trainable, respectively. This mode focuses on finetuning higher-level features specific to the task while preserving general features learned from other datasets. Subsequently, training switches to the release mode, where all layers are made trainable, allowing for full adaptation and refinement. During the lock mode training, only half of the dataset is used to prevent early overfitting, while the full dataset is utilized during the release mode training to ensure comprehensive learning. This Lock-Release strategy helps prevent the model from overfitting too heavily towards one task when exposed to multiple tasks and datasets, ensuring a more balanced learning process.

A Lock-Release strategy was attempted for classification but found ineffective, so it was not applied. Unlike localization and segmentation, which have more parameters to tune, classification relies on lightweight heads, making Lock-Release less impactful.

### 3.4 Student-Teacher Learning Paradigm

To further mitigate the issue of forgetting and prevent overfitting towards any single task, thereby balancing and stabilizing the learning process across diverse tasks and datasets, a student-teacher learning paradigm is used in the embodiments. The teacher model uses the same architecture as the student model, and both are initialized with the same weights. The student model is updated through standard training processes, while the teacher model is updated using an exponential moving average (EMA) based on the student's learning at the end of each epoch. Furthermore, as shown in FIG. 1, a consistency loss is incorporated for the features from the backbone, the localization encoder, and the segmentation decoder between the student and teacher models. This consistency loss ensures that the features learned by the student model remain aligned with those of the teacher model, promoting stability and improved performance during training. The student-teacher learning paradigm enhances generalization across classification, localization, and segmentation tasks, resulting in improved performance and robustness on various tasks. After pretraining, the teacher model from the disclosed embodiments is used for the downstream tasks.

### IV. Experiments and Results

Pretraining Foundation X. An embodiment is pretrained on 11 datasets (see Table 1 presented in FIG. 5) encompassing three common medical tasks: disease classification, localization, and segmentation. Among these datasets, all provide disease classification, two include localization and three offer segmentation mask annotations. Since CANDID-PTX and SIIM-ACR Pneumothorax are annotated only with disease masks, localization bounding boxes are derived from them, resulting in a total of four localization tasks. The official dataset splits are used when available and perform random splits (70% train, 10% val, 20% test) for those without.

Finetuning Foundation X. An additional five publicly available chest X-ray datasets were collected to finetune the disclosed embodiments on organ segmentation and localization tasks. CheXmask offers a comprehensive collection of uniformly annotated chest radiographs compiled from five public sources: ChestX-ray8, Chexpert, MIMIC-CXR-JPG, Padchest, and VinDr-CXR. It includes segmentation masks for the heart, left lung, and right lung. From these provided segmentation masks, localization bounding boxes were derived for the same organs. The VinDr-CXR portion of the dataset was used to localize and segment the organs. Furthermore, the NIH Montgomery, VinDr-RibCXR, and JSRT datasets were used for organ segmentation in the embodiments. NIH Montgomery provides lung masks, VinDr-RibCXR provides rib masks, and JSRT provides heart, lung, and clavicle masks.

In particular, the localizability loss term encourages the model to capture distinctive embeddings for different anatomical structures across varying scales. Moreover, the composability and decomposability loss terms empower the model with a profound understanding of the part-whole relations in both bottom-up and top-down manners.

4.1. Foundation X Achieves Performance Gains through Extensive Annotation Utilization

Experimental Setup: The disclosed embodiments pretrain on a large-scale dataset collection, utilizing the first 11 datasets from Table 1 presented in FIG. 5, which encompass 20 tasks (C₁-C₁₁ for classification, L₁-L₆ for localization, and S₁-S₃ for segmentation). The Swin-B backbone is initialized with Ark-6 pre-trained weights. For each dataset, the disclosed embodiments are pretrained on all tasks sequentially. For example, epoch x is dedicated to classification, x+1 to localization, and x+2 to segmentation. If a dataset lacks annotations for a specific task, that task is simply skipped. One cycle is defined as the model completing training on all 20 tasks listed in Table 1 presented in FIG. 5. During pretraining, a Student-Teacher learning paradigm, and Cyclic and Lock-Release pretraining strategies are used. This approach ensures comprehensive exposure to all tasks and datasets, promoting better generalization and robust performance in medical imaging.

Results and Analysis: By utilizing the Cyclic and Lock-Release pretraining strategies, the disclosed embodiments demonstrate significantly improved performance on most tasks when pretrained on large-scale datasets. Table 4 presented in FIG. 8 shows the disclosed embodiments achieve better performance on a majority of tasks compared to the baseline models, which are trained independently on specific datasets and tasks.
† All baselines use Swin-B as the backbone with Ark-6 pretrained weights. The classification baseline uses only Swin-B, the localization baseline uses Swin-B+DINO [38], and the segmentation baseline uses Swin-B+UperNet.
* Values inside parentheses indicate the finetuning results of Foundation X, while the preceding values represent the pretraining results.

The table presents the results from pretraining Foundation X, compared to baseline models, across 11 datasets encompassing 20 tasks (see Table 1). Foundation X is trained sequentially on these tasks using the Cyclic and Lock-Release pretraining strategies, which helps it generalize efficiently and retain knowledge of previous tasks. The results indicate that Foundation X outperforms most of the baselines, which are trained individually on specific datasets and tasks. This highlights the effectiveness of the integrated multitask learning approach in improving model performance and generalization ability. The arrow shows Foundation X's performance gain/loss compared with the baseline performance. Notably, due to the embodiments'superior pretraining strategy, the disclosed embodiments do not exhibit overfitting toward a single task, resulting in consistent improvement across various datasets and tasks. In contrast, baseline models are fully finetuned on individual datasets, giving them an advantage in single-task performance. Consequently, during the embodiments'large-scale pretraining, it is expected that some tasks may face difficulties due to the need to balance learning across diverse datasets and tasks. Despite this challenge, the disclosed embodiments achieve comparable or better results than the baselines in most cases. To address underperforming tasks during pretraining, the disclosed embodiments are further finetuned from the latest checkpoint, achieving better results than the baselines. As shown in Table 4 presented in FIG. 8, the NIH ChestX-ray 14 disease classification task improves to 83.35%, the localization performance on TBX11K increases to 81.80%, the ChestX-Det classification raises to 89.89%, and ChestX-Det localization raises to 43.98%. However, finetuning for the ChestX-Det segmentation task (79.17%) showed limited improvement, likely due to the low class-to-data ratio.

### 4.2. Foundation X Enhances Performance for Organ Localization and Segmentation

Experimental Setup: The disclosed embodiments are pretrained exclusively on organ localization and segmentation tasks using the VinDr-CXR dataset. The official training split is evenly divided, resulting in 7,500 non-overlapping images for both localization and segmentation pretraining tasks. Additionally, the dataset is further divided into three nonoverlapping subsets for three specific organs (heart, left lung, and right lung). This careful partitioning ensures a rigorous assessment of the embodiments'performance in localizing and segmenting these three organs independently. To establish baseline performance, DINO is trained for localization and UperNet for segmentation on the tasks separately. To demonstrate the embodiments'superior pretraining strategy on localization and segmentation tasks, the disclosed embodiments are pretrained using both localization and segmentation branches along with the Cyclic and Lock-Release pretraining strategies. The resulting model is referred to as Foundation X-LS (Table 3 presented in FIG. 7) since it is trained exclusively on Localization and Segmentation tasks. In Table 3, Baseline localization and segmentation models are trained separately using DINO and UperNet to localize and segment the heart, left lung, and right lung in the VinDr-CXR dataset, each employing a single head for three classes. In contrast, the Foundation X-LS model according to the disclosed embodiments handles both tasks together in pretraining, showing enhanced performance. The vertical arrow highlights Foundation X's performance improvements over the baselines. To demonstrate that Foundation X-LS provides superior fine-grained features, the model is further finetuned on three organ segmentation tasks: JSRT, NIH Montgomery, and VinDr-RibCXR. Lastly, the model's effectiveness is evaluated in few-shot learning setups using the JSRT-clavicle dataset. Here, the results are compared against two pretraining baselines: Ark and POPAR. Ark utilizes the Swin-B backbone pretrained on 6 chest X-ray datasets in a supervised setup using the cyclic pretraining strategy. POPAR, a self-supervised method, also employs Swin-B pretrained on NIH ChestX-ray14 images, leveraging consistent and recurrent anatomical patterns in medical images to learn patch-level spatial relationships and fine-grained appearance features. For comparison on the segmentation task, a baseline is built using Swin-B+UperNet, where the Swin-B backbone is initialized with Ark-6 or POPAR pretrained weights.

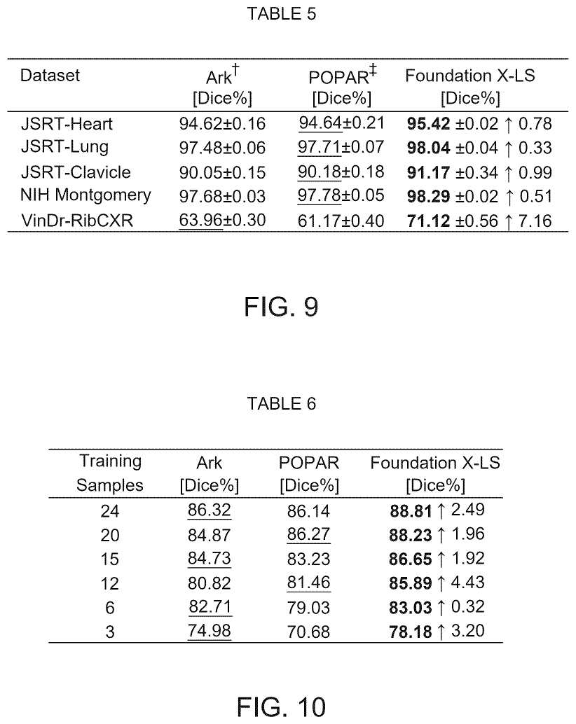

Results and Analysis: As shown in Table 3 presented in FIG. 7, compared to the two baseline methods, DINO and UperNet, which are independently trained for specific tasks, the Foundation X-LS model—pretrained by sequentially incorporating both localization and segmentation—achieves the best performance. Specifically, during pretraining, substantial gains were observed in localization, with performance increases of 8.24% for the heart, 4.86% for the left lung, and 4.36% for the right lung. Additionally, segmentation tasks show improvements of 0.33%, 0.11%, and 0.10% for the heart, left lung, and right lung, respectively. Table 5 presented in FIG. 9 demonstrates the Foundation X-LS model's finetuning performance on the individual task.
† indicates the disclosed embodiments adopt this performance reported by the original authors.
‡ POPAR is finetuned for the baselines.

With reference to Table 5, the disclosed embodiments initialize Foundation X-S with weights from the Foundation X-LS model, trained on VinDr-CXR for organ localization and segmentation. After finetuning on other target tasks, Foundation X-LS shows notable performance gains over Ark and POPAR. The vertical arrow indicates its improvements over the second-best method (underlined). When finetuning on the JSRT dataset, performance gains were observed of 0.78% for heart, 0.33% for lung, and 0.99% for clavicle segmentation. Additionally, gains of 0.51% for the NIH Montgomery and 7.16% were noted for the VinDr-RibCXR segmentation task. In a few-shot setup for clavicle segmentation on the JSRT dataset (Table 6 presented in FIG. 10), the disclosed embodiments consistently outperform Ark and POPAR across all training sample sizes. Table 6 shows Foundation X-LS is trained on VinDr-CXR for organ localization and segmentation and then finetuned for JSRT clavicle segmentation in a few-shot learning setup. The results consistently show that Foundation X-LS outperforms Ark and POPAR, with the vertical arrow indicating performance boosts over the second-best method (underlined).

4.3. Foundation X Maximizes Performance with Cross-Dataset and Cross-Task Learning

Experimental Setup: The generalizability and effectiveness of the disclosed embodiments is assessed across datasets and tasks. Specifically, the disclosed embodiments are evaluated to determine 1) how well the disclosed embodiments pretrained on one dataset performs on another, and 2) how the disclosed embodiments perform on two other tasks when pretrained by the third task within the same dataset. During the pretraining of the embodiments, the model was evaluated on the testing sets of all tasks across all datasets after each epoch, generating a series of Epoch V.S. Performance graphs. The goal is to observe how testing performance changes over time when the model is trained on the same dataset (focused training) compared to when it is trained on other datasets (unfocused training). FIGS. 2A-2C present the results from focused training, unfocused training, and the best results from focused training for three selected datasets (RSNA Pneumonia, SIIM-ACR, and CANDID-PTX). Comprehensive plots for all datasets with multiple tasks are included in the supplementary description.

FIGS. 2A-2C graphically illustrate Cross-Dataset and Cross-Task Learning Analysis. The figures demonstrate the performance trends of Foundation X across multiple datasets for both focused and unfocused training scenarios. Focused training refers to scenarios where the model is explicitly trained on the specific dataset being evaluated. In contrast, unfocused training refers to scenarios where the model is trained on other datasets and not directly on the one being evaluated. FIG. 2A represents classification tasks. FIG. 2B represents localization tasks, and FIG. 2C represents segmentation tasks. Bold lines indicate focused training results, while light-lines show unfocused training results. Dashed lines represent the best testing outcomes from focused training. In some cases, unfocused training surpasses focused training, highlighting the benefits of cross-task and cross-dataset learning in enhancing Foundation X's capabilities. The model efficiently generalizes, retains knowledge of previous tasks, and avoids overfitting during pretraining.

Results and Analysis: FIGS. 2A-2C demonstrate positive performance trends across the datasets for both focused and unfocused training on each dataset. This indicates that the disclosed embodiments can effectively generalize and improve performance even without explicit training on specific tasks of the evaluated dataset. During unfocused training (light colored line), the performance dips are common initially, but improvement is typically observed over time. In all cases shown in FIGS. 2A-2C, the results from unfocused training do not drift away from the task, indicating that the model can generalize efficiently and retain knowledge of previous tasks due to the Student-Teacher learning paradigm, Cyclic and Lock-Release pretraining strategies. The model performs consistently across all datasets and tasks. In some cases, unfocused training even outperforms focused training, highlighting the benefits of cross-task and cross-dataset learning in the embodiments.

### V. Discussion

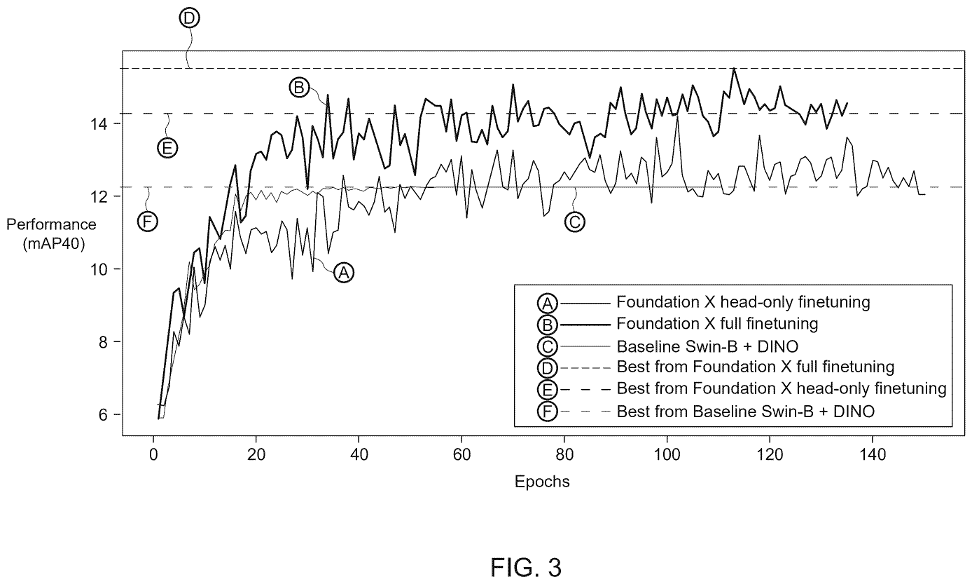

The disclosed embodiments provide a model that outperforms task-specific models by collaboratively learning from multiple datasets and tasks. Moreover, finetuning is used if a task-specific model is adapted to other tasks, such as adapting a classification pretrained model to a localization task. The disclosed embodiments address evolving diagnostic task requirements through easy and quick finetuning. FIG. 3 graphically illustrates full finetuning of Foundation X outperforms both head only finetuning Foundation X and the baseline Swin-B+DINO model with Ark-6 initialized backbone weights. All three settings followed the same hyperparameters as mentioned in the supplementary description below. As observed in FIG. 3, finetuning the disclosed embodiments that are pretrained only on the classification task of the VinDr-CXR dataset, amongst other pretraining datasets and tasks (Refer to Table 1 presented in FIG. 5), achieves superior localization performance compared to the baseline model for the same dataset. This is attributed to a performance gain to the knowledge gathered from the Cyclic and Lock-Release pretraining strategies across all tasks and datasets.

To further assess the embodiments, the latest checkpoint from Foundation X-CLS is finetuned using full finetuning, head-only finetuning and compared with the localization baseline for the VinDr-CXR localization dataset. In full finetuning, the model is trained on the VinDr-CXR localization dataset with a randomly initialized localization decoder. In head-only finetuning, the backbone and localization encoder are frozen, leaving only the new task head (localization decoder) trainable, with ≈9.6 million parameters. While it is challenging to train a model with most of its layers frozen, head-only finetuning achieved 12.27% mAP 40 at the 49^{th} epoch, where the baseline achieved its best result of 12.26% mAP 40 (see FIG. 3). The head only finetuning of the embodiments, moreover, has significantly fewer trainable parameters than the baseline model (107 M) but outperforms the latter by achieving its best result of 14.29% mAP 40 at the 101^{st} epoch. Full finetuning of the embodiments, on the other hand, surpassed both head-only finetuning and baseline at epoch 49 with 13.10% mAP 40 and went on to achieve the best result of 15.51% mAP 40 at the 112^{th} epoch. This reinforces that the embodiments, by leveraging knowledge from diverse datasets and utilizing Cyclic and Lock-Release pretraining, boost performance, even with minimal (head-only) finetuning.

### VI. Supplementary Description

### A. Experiment Details

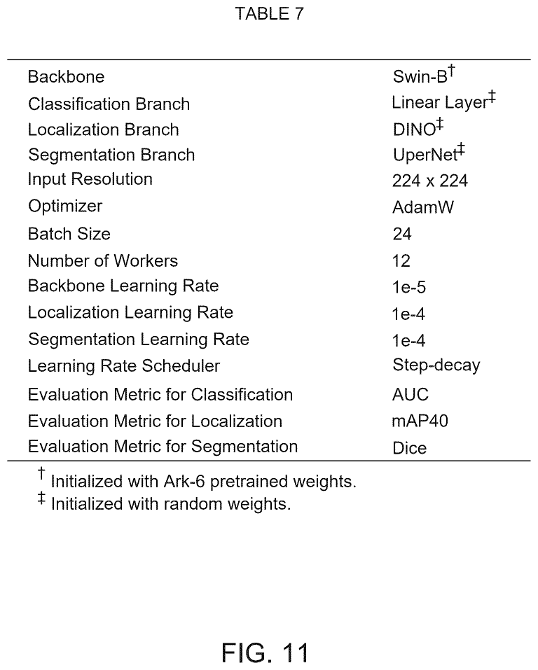

The following describes the setup of the training process for Foundation X. The backbone is Swin-B, initialized with Ark-6 pretrained weights. For the classification task, linear layers serve as classification heads. For localization, the DINO localization approach is integrated and modified to handle multiple datasets with one localization encoder and multiple localization decoders. For segmentation, UperNet is used, modified to include multiple segmentation heads. Foundation X is pretrained on all 11 datasets (see Table 1 presented in FIG. 5) using a single A 100 GPU, employing the Cyclic and Lock-Release pretraining strategies. The Student-Teacher learning paradigm is used, where the teacher model is an exact copy of the student model at the start. The teacher model is updated after each epoch using an exponential moving average (EMA) with a momentum of 0.80. The configuration for Foundation X is detailed in Table 7 presented in FIG. 11, in which:
† Initialized with Ark-6 pretrained weights.
‡ Initialized with random weights.

### B. Model Parameters

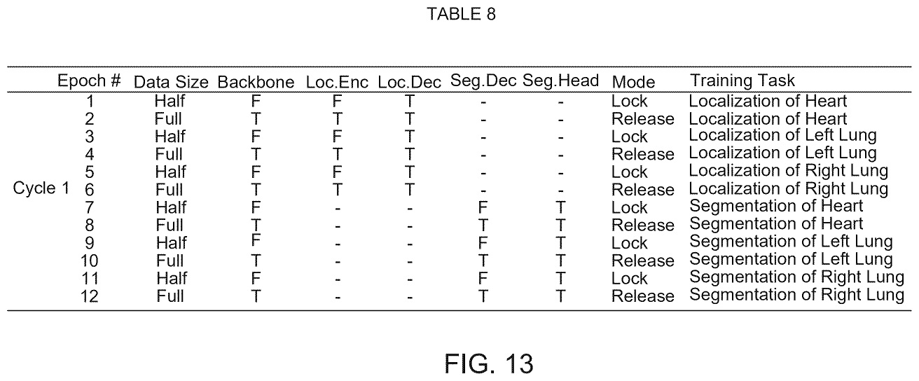

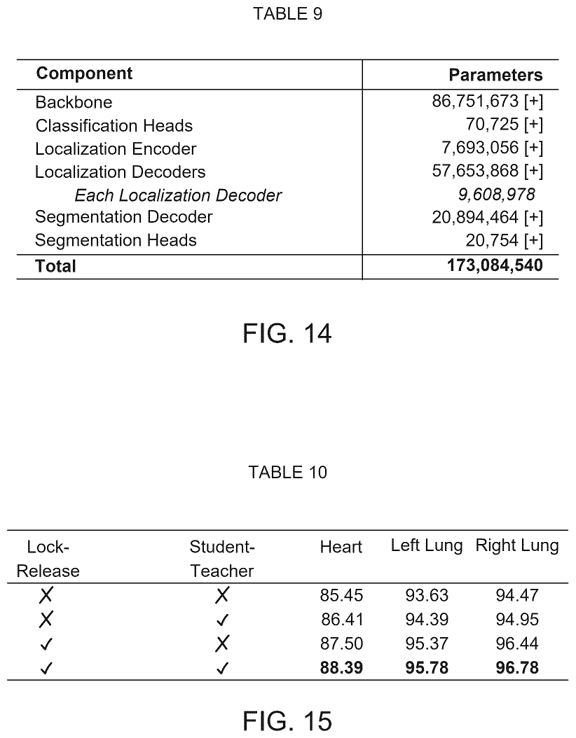

The Foundation X model consists of several key components, contributing to a total of approximately 173 million parameters (See Table 9 presented in FIG. 14). The backbone, responsible for feature extraction, accounts for 86.8 million parameters. The localization encoder adds 7.7 million parameters, while the localization decoders total 57.6 million, with each decoder contributing 9.6 million. The segmentation decoder comprises 20.9 million parameters. Although adding a dedicated localization decoder for each dataset increases the model size, only the relevant decoder is active during training, with the others, along with the classification and segmentation heads, remaining frozen. This approach keeps the computational load manageable and ensures efficient GPU utilization.

### C. Lock-Release Pretraining Strategy

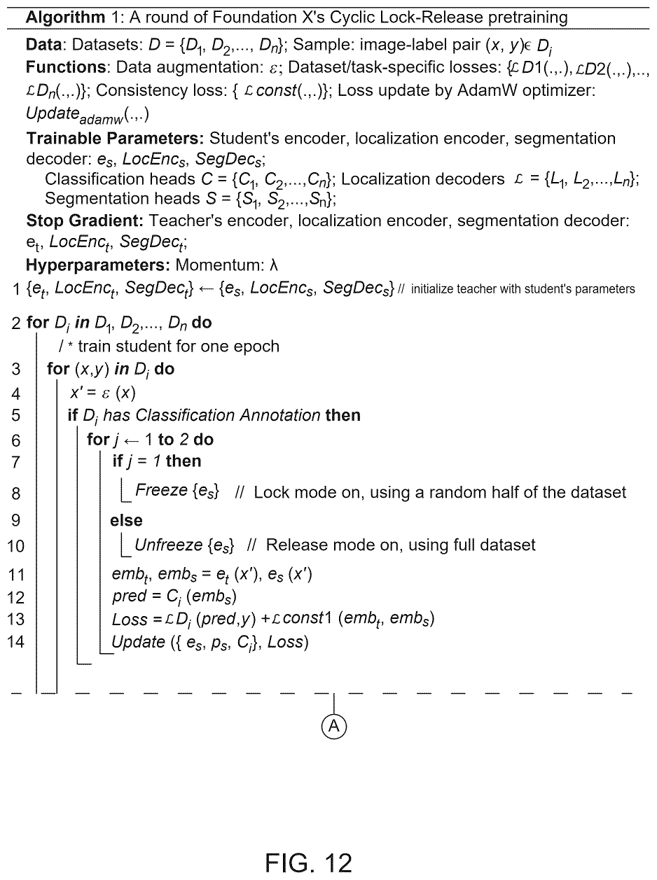

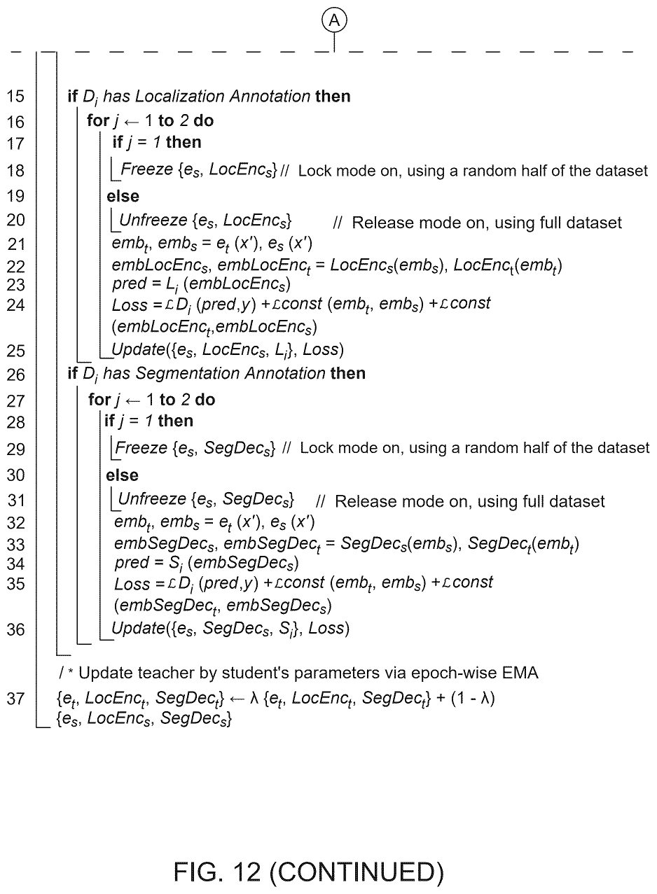

Foundation X effectively handles classification, localization, and segmentation tasks. The model leverages the Student-Teacher learning paradigm along with Cyclic and Lock-Release pretraining strategies, ensuring it retains general knowledge for all tasks while avoiding overfitting to any single task. Algorithm 1 presented in FIG. 12 provides example pseudocode in support of the disclosed embodiments including the lock-release pretraining strategy. In Table 8 presented in FIG. 13, the Lock-Release pretraining strategy is illustrated using the VinDr-CXR organ dataset for organ localization and segmentation. For this demonstration, localization and segmentation of the heart, left lung, and right lung are treated as separate tasks. The model completes a single cycle when it goes through all tasks once (from epoch #1 to #12). “F” denotes a frozen component, and “T” denotes a trainable component. In Lock mode, the model is trained using half of the dataset, while in Release mode, it is trained using the full dataset. After each epoch in Release mode, the model is tested on the localization and segmentation of the heart, left lung, and right lung.

### D. Cross-Dataset and Cross-Task Learning Analysis

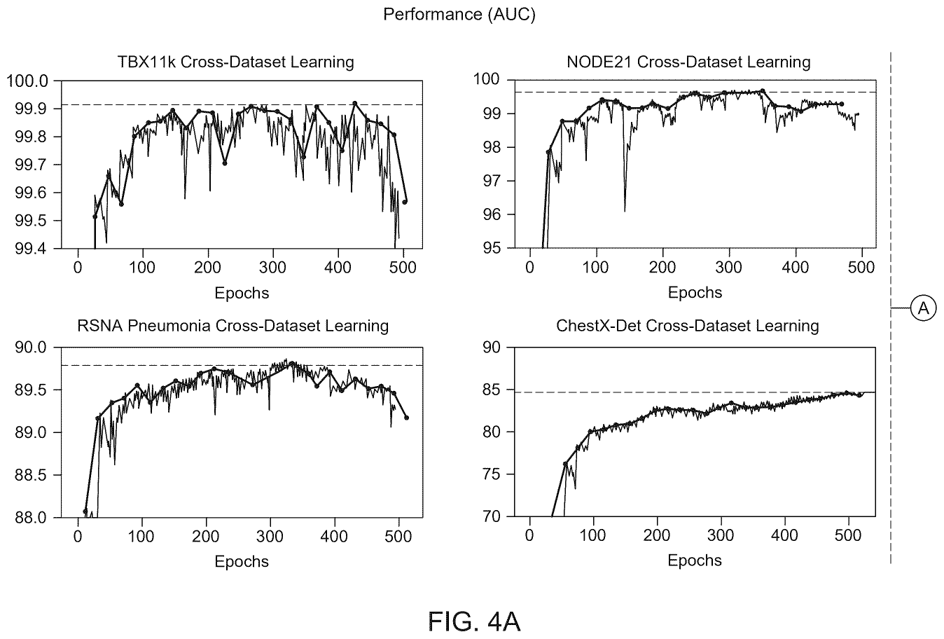

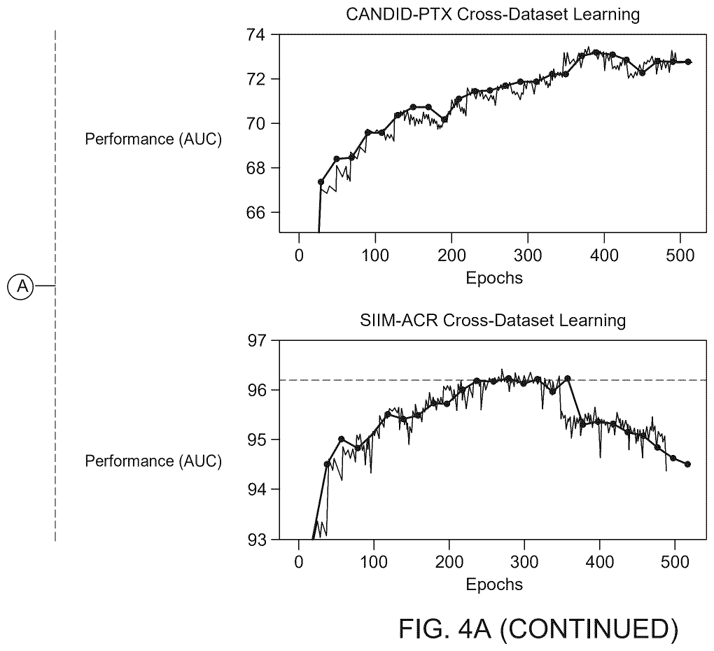

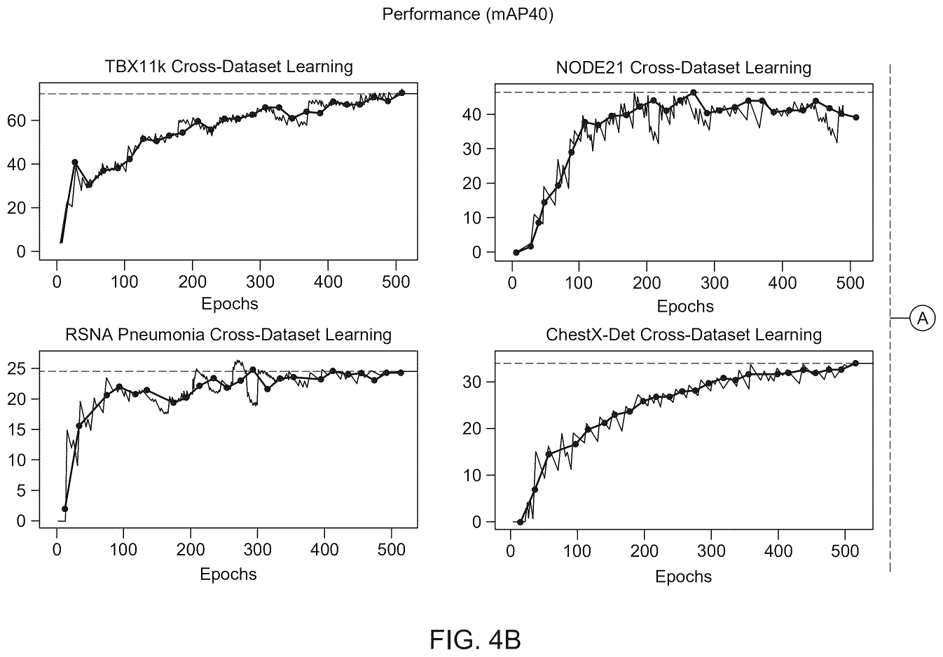

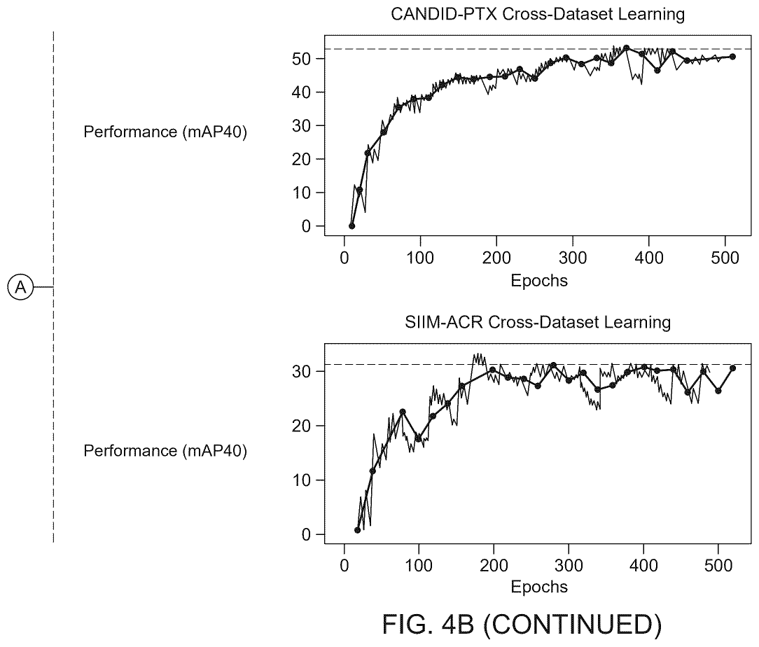

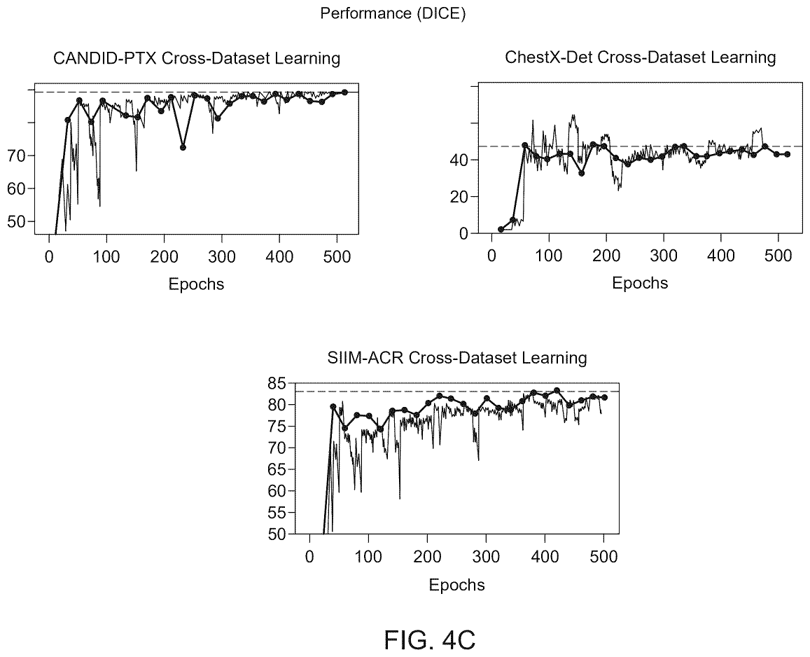

The full figure illustrating the Cross-Dataset and Cross-Task learning analysis for all six datasets is included in this supplementary description (see FIGS. 4A-4C). FIGS. 4A-4C highlight the performance trends of Foundation X across various datasets under both focused and unfocused training scenarios, showcasing its ability to generalize and retain knowledge effectively through the Cyclic and Lock-Release pretraining strategies. Plots are included for these six datasets because they contain multiple tasks, including classification, localization, and segmentation. In particular, FIGS. 4A-4C graphically illustrate Cross-Dataset and Cross-Task Learning Analysis. The figures demonstrate the performance trends of Foundation X across multiple datasets for both focused and unfocused training scenarios. Focused training refers to scenarios where the model is explicitly trained on the specific dataset being evaluated, while unfocused training refers to scenarios where the model is trained on other datasets and not directly on the dataset being evaluated. The lines in FIGS. 4A, 4B and 4C represent the classification, localization, and segmentation tasks, respectively. Bold lines indicate the testing results during focused training, where the model is explicitly trained on the specific dataset. Light lines show the testing results during unfocused training, where the model is trained on other datasets but tested on the specific dataset. Dashed lines represent the best testing results achieved from focused training for each specific dataset. The results indicate that, during unfocused training, initial performance dips are common as the model is not explicitly trained on the specific dataset. However, performance improves over time, demonstrating the model's ability to generalize effectively and retain knowledge due to the Cyclic and Lock-Release pretraining strategies. In all cases, the unfocused training results do not drift away from the task, highlighting the model's efficient generalization and knowledge retention. Additionally, in some instances, unfocused training achieves even better performance than focused training, showcasing the advantages of cross-task and cross-dataset learning in enhancing the overall capabilities of Foundation X.

### E. Ablation Study

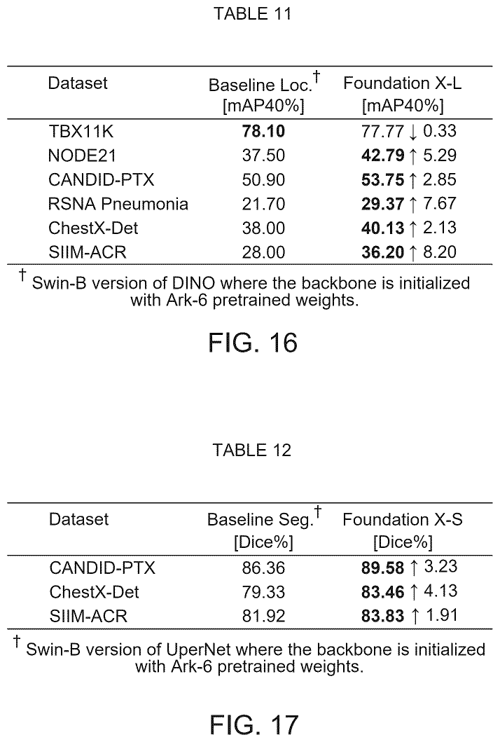

The ablation studies demonstrate the effectiveness of the Student-Teacher learning paradigm, Cyclic and Lock-Release pretraining strategies across various tasks. Foundation X-L (see Table 11 presented in FIG. 16), trained on six disease localization tasks, generally outperforms the baseline model Swin-B+DINO in which:
† Swin-B version of DINO where the backbone is initialized with Ark-6 pretrained weights.

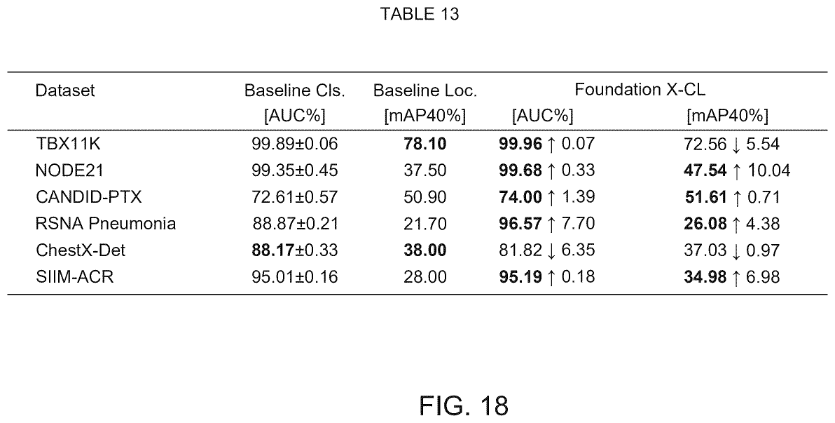

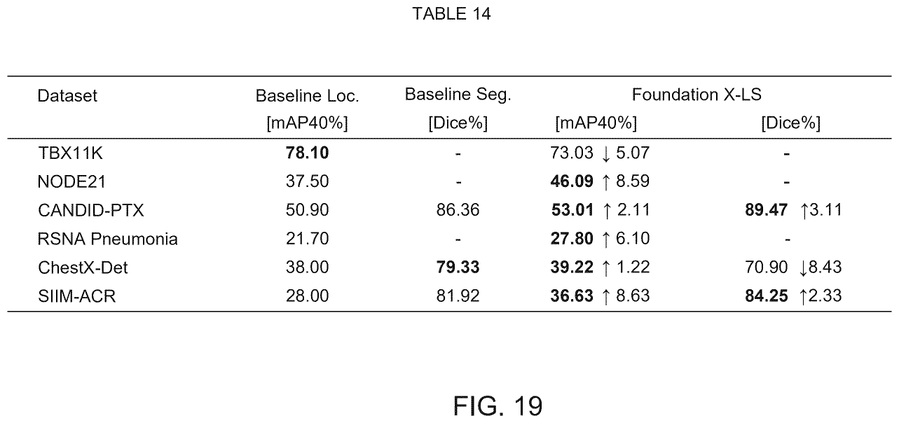

Table 11 shows Foundation X-L trained on six disease localization tasks utilizing Cyclic and Lock-Release pretraining strategies and its performance compared with the baseline model, DINO. In most cases, Foundation X-L outperforms the baseline across the datasets during pretraining. Similarly, Foundation X-S (see Table 12 presented in FIG. 17), trained on three disease segmentation datasets, consistently surpasses the baseline model Swin-B+UperNet, in which:
† Swin-B version of UperNet where the backbone is initialized with Ark-6 pretrained weights. Table 12 shows Foundation X-S trained on three disease segmentation datasets using the Cyclic and Lock-Release pretraining strategies and its performance compared with the baseline model, UperNet. In all cases, Foundation X-S outperforms the baseline across the datasets during pretraining. Additionally, Foundation X-CL (see Table 13 presented in FIG. 18), which handles both classification and localization tasks, and Foundation X-LS (see Table 14 presented in FIG. 19), which integrates localization and segmentation tasks, both show superior performance compared to their respective baseline methods in most cases.

Table 13 shows Foundation X-CL trained on six disease datasets, each containing both classification and localization annotations, using Cyclic and Lock-Release pretraining strategies. The table demonstrates that, in most cases, Foundation X-CL outperforms the baseline methods during pretraining.

Table 14 shows Foundation X-LS trained on six disease localization and three disease segmentation datasets, using the Cyclic and Lock-Release pretraining strategies. The table demonstrates that, in most cases, Foundation X-LS outperforms the baseline methods during pretraining.

The ablation study presented in Table 10 as presented in FIG. 15 highlights the impact of incorporating the Lock-Release pretraining strategy and the Student-Teacher learning paradigm on the performance of the Foundation X model. The table shows the ablation study is conducted on the VinDr-CXR organ localization dataset. The model is evaluated with and without the Lock-Release pretraining strategy, as well as with and without the Student-Teacher model. The results demonstrate that the Foundation X model achieves comparatively better performance when both the Lock-Release pretraining strategy and the Student-Teacher learning paradigm are employed. The results demonstrate that when both components are enabled, the model achieves the best performance across all evaluated VinDr-CXR organs (Heart, Left Lung, and Right Lung) localization. Specifically, the combination of Lock-Release and Student-Teacher results in the highest mAP, with scores of 88.39% for Heart, 95.78% for Left Lung, and 96.78% for Right Lung. These findings suggest that each component complements the other, with the Lock-Release strategy preventing task-specific overfitting and the Student-Teacher paradigm ensuring stable learning by reducing drastic model shifts. Together, these strategies create a synergistic effect that enhances the model's generalization and overall performance, outperforming configurations where one or both components are disabled. This highlights the importance of integrating both the Lock-Release strategy and the Student-Teacher paradigm to maximize the effectiveness of embodiments of the disclosure.

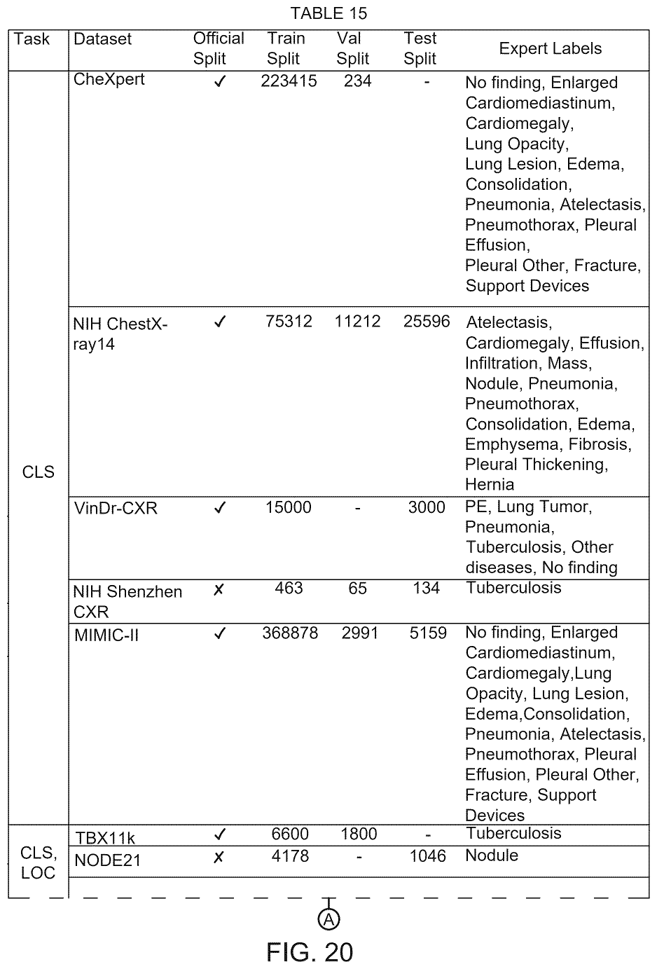

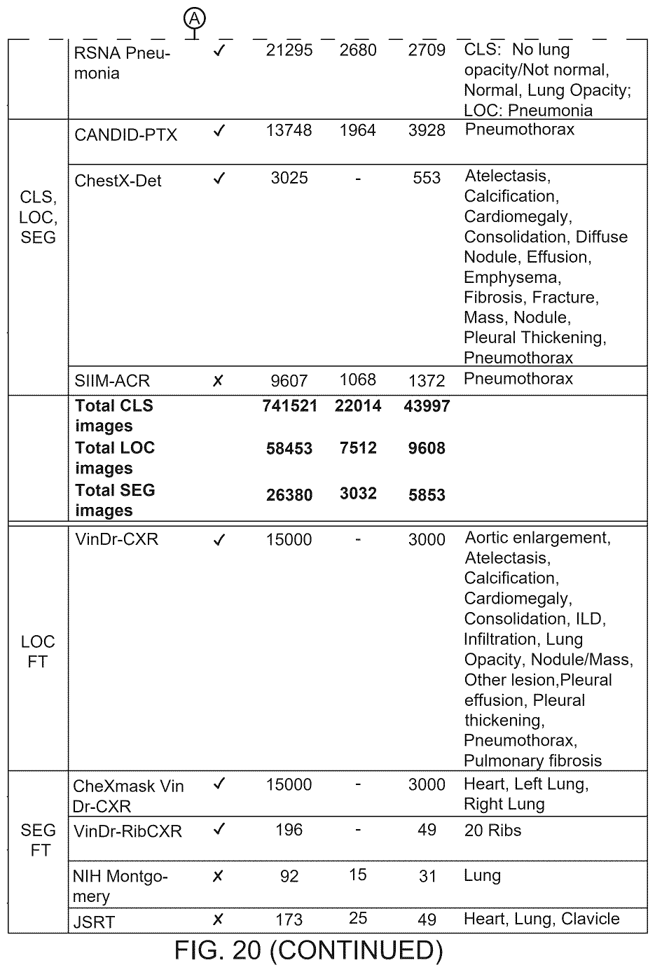

With reference to Table 15 presented in FIG. 20, Foundation X was pretrained on the above 11 classification datasets, 6 localization datasets, and 3 segmentation datasets. CLS stands for classification task, LOC stands for localization task, SEG stands for segmentation task. “CLS, LOC” denotes the datasets used for classification and localization tasks. “CLS, LOC, SEG” denotes the datasets used for classification, localization, and segmentation tasks. “LOC FT” and “SEG FT” denotes the datasets used only during the finetuning of the localization and segmentation task, respectively.

### VII. CONCLUSION

The disclosed embodiments provide an advanced model for chest X-ray analysis designed to handle classification, localization, and segmentation tasks with a shared backbone. By leveraging the Cyclic and Lock-Release pretraining strategies, embodiments achieve significant performance improvements across diverse datasets, confirming the disclosed embodiments capability for combined task learning. The disclosed embodiments surpass baselines across various datasets and tasks while maximizing the utilization of all available annotations. This efficiency reduces annotation costs and enhances the effectiveness of data analysis and processing in medical image analysis. Overall, the disclosed embodiments provide a robust and versatile solution for advancing medical imaging technology.

The disclosed embodiments provide a computer-implemented method for developing a deep learning model, comprising: receiving a plurality of image datasets (chest x-ray image datasets) each including one or more of a plurality of inconsistent or heterogeneous (expert-level) annotations across a corresponding one or more of a plurality of tasks including classification (identifying diseases), localization (generating bounding boxes), and segmentation (delineating boundaries) tasks employed in (medical) imaging; and training, with the plurality of image datasets, the learning model to retain general knowledge across all of the plurality of tasks while preventing overfitting to any one of the plurality of tasks, using an end-to-end framework comprising a student-teacher model, a shared backbone, a classification task branch, a localization task branch, and a segmentation task branch, the framework integrating and concurrently performing the plurality of tasks on the plurality of image datasets, including implementing a lock-release pretraining strategy that involves cyclically training the learning model using the plurality of image datasets and sequentially processing each of the plurality of image datasets.

According to the disclosed embodiments, the computer-implemented method comprises: extracting from the image dataset, by a student model of the end-to-end framework, relevant features for the respective tasks to be performed by the classification task branch, the localization task branch, and the segmentation task branch; and sequentially directing the relevant features to one or more of the classification task branch, the localization task branch, and the segmentation task branch of the end-to-end framework.

According to an embodiment, the relevant features for the tasks to be performed by the classification branch comprise high-level representations of images in the image dataset for classification. The method further comprises processing the high-level representations of images in the image dataset through a classification head of the classification task branch.

According to an embodiment, the classification head comprises a linear classifier and wherein processing the high-level representations of images in the image dataset through the classification head of the classification task branch comprises processing the high-level representations of images in the image dataset the linear classifier.

According to an embodiment, the relevant features for the tasks to be performed by the localization branch comprise specific regions of interest in the images of the image dataset for localization, the method further comprising passing the specific regions of interest in the images of the image dataset through a localization encoder and corresponding localization decoder module of the localization task branch.

According to an embodiment, the localization decoder module comprises a plurality of localization decoders so that each localization dataset has a dedicated decoder allowing processing of multiple tasks.

According to an embodiment, the relevant features for the tasks to be performed by the segmentation branch comprise boundaries of regions for segmentation in the images of the image data set, the method further comprising passing the boundaries of regions for segmentation in the images of the image data set through a segmentation decoder and a segmentation head module of the segmentation task branch. According to this embodiment, the segmentation head module comprises a plurality of segmentation heads to process different segmentation tasks.

According to an embodiment, cyclically training the learning model using the plurality of image datasets comprises revisiting each one of the plurality of tasks in every training round, thereby reinforcing a learning process and preventing the learning model from forgetting previously acquired knowledge thereby enabling the learning model to learn from the plurality of tasks.

According to an embodiment, training the learning model with the plurality of image datasets comprises training the learning model in a first mode where a majority of early layers of the learning model are frozen and only a subset of upper layers of the learning model are trainable. According to this embodiment, training the learning model in the first mode comprises, for localization tasks and segmentation tasks, making only the localization decoder module and the segmentation head module trainable, respectively, to finetune higher-level features specific to a relevant task while preserving general features learned from other datasets. This embodiment further comprises training the learning module in a second mode, where all layers of the training model are trainable, subsequent to training the learning module in the first mode. According to this embodiment, during the first mode of training the learning model, only half of the image dataset is used to prevent early overfitting, and during the second mode of training the learning model, all the image dataset is used for learning.

According to an embodiment, the student-teacher model comprises an architecture of a student model that is the same as an architecture of a teacher model, the method further comprising: initializing the student model and the teacher model with a same weight; updating the student model through a standard training process; and updating the teacher model using an exponential moving average based on learning of the student model at an end of each training cycle.

According to an embodiment, the training model comprises a consistency loss for the relevant features from the shared backbone, the localization encoder, and the segmentation decoder between the student model and the teacher model, so that relevant features learned by the student model remain aligned with relevant features learned from the teacher model.

What is claimed is:

1. A computer-implemented method for developing a deep learning model, comprising:
receiving a plurality of image datasets each including one or more of a plurality of inconsistent or heterogeneous annotations across a corresponding one or more of a plurality of tasks including classification, localization, and segmentation tasks employed in imaging; and
training, with the plurality of image datasets, the learning model to retain general knowledge across all of the plurality of tasks while preventing overfitting to any one of the plurality of tasks, using an end-to-end framework comprising a student-teacher model, a shared backbone, a classification task branch, a localization task branch, and a segmentation task branch, the framework integrating and concurrently performing the plurality of tasks on the plurality of image datasets, including implementing a lock-release pretraining strategy that involves cyclically training the learning model using the plurality of image datasets and sequentially processing each of the plurality of image datasets.

2. The computer-implemented method of claim 1, wherein sequentially processing each of the plurality of image datasets comprises:
extracting from the image dataset, by a student model of the end-to-end framework, relevant features for the respective tasks to be performed by the classification task branch, the localization task branch, and the segmentation task branch; and
sequentially directing the relevant features to one or more of the classification task branch, the localization task branch, and the segmentation task branch of the end-to-end framework.

3. The computer-implemented method of claim 2, wherein the relevant features for the tasks to be performed by the classification branch comprise high-level representations of images in the image dataset for classification, the method further comprising processing the high-level representations of images in the image dataset through a classification head of the classification task branch.

4. The computer-implemented method of claim 3, wherein the classification head comprises a linear classifier and wherein processing the high-level representations of images in the image dataset through the classification head of the classification task branch comprises processing the high-level representations of images in the image dataset the linear classifier.

5. The computer-implemented method of claim 2, wherein the relevant features for the tasks to be performed by the localization branch comprise specific regions of interest in the images of the image dataset for localization, the method further comprising passing the specific regions of interest in the images of the image dataset through a localization encoder and corresponding localization decoder module of the localization task branch.

6. The computer-implemented method of claim 5, wherein the localization decoder module comprises a plurality of localization decoders so that each localization dataset has a dedicated decoder allowing processing of multiple tasks.

7. The computer-implemented method of claim 2, wherein the relevant features for the tasks to be performed by the segmentation branch comprise boundaries of regions for segmentation in the images of the image data set, the method further comprising passing the boundaries of regions for segmentation in the images of the image data set through a segmentation decoder and a segmentation head module of the segmentation task branch.

8. The computer-implemented method of claim 7, wherein the segmentation head module comprises a plurality of segmentation heads to process different segmentation tasks.

9. The computer-implemented method of claim 1, wherein cyclically training the learning model using the plurality of image datasets comprises revisiting each one of the plurality of tasks in every training round, thereby reinforcing a learning process and preventing the learning model from forgetting previously acquired knowledge thereby enabling the learning model to learn from the plurality of tasks.

10. The computer-implemented method of claim 1, wherein training, with the plurality of image datasets, the learning model, comprises training the learning model in a first mode where a majority of early layers of the learning model are frozen and only a subset of upper layers of the learning model are trainable.

11. The computer-implemented method of claim 10, wherein training the learning model in the first mode comprises, for localization tasks and segmentation tasks, making only the localization decoder module and the segmentation head module trainable, respectively, to finetune higher-level features specific to a relevant task while preserving general features learned from other datasets.

12. The computer-implemented method of claim 11, further comprising training the learning module in a second mode, where all layers of the training model are trainable, subsequent to training the learning module in the first mode.

13. The computer-implemented method of claim 12, wherein during the first mode of training the learning model, only half of the image dataset is used to prevent early overfitting, and during the second mode of training the learning model, all the image dataset is used for learning.

14. The computer-implemented method of claim 1, wherein the student-teacher model comprises an architecture of a student model that is the same as an architecture of a teacher model, the method further comprising:
initializing the student model and the teacher model with a same weight;
updating the student model through a standard training process; and
updating the teacher model using an exponential moving average based on learning of the student model at an end of each training cycle.

15. The computer-implemented method of claim 1, wherein the training model comprises a consistency loss for the relevant features from the shared backbone, the localization encoder, and the segmentation decoder between the student model and the teach model, so that relevant features learned by the student model remain aligned with relevant features learned from the teacher model.

16. A system comprising:
a memory to store instructions;
a processor to execute the instructions stored in the memory to perform the following operations:
receiving a plurality of image datasets each including one or more of a plurality of inconsistent or heterogeneous annotations across a corresponding one or more of a plurality of tasks including classification, localization, and segmentation tasks employed in imaging; and
training, with the plurality of image datasets, the learning model to retain general knowledge across all of the plurality of tasks while preventing overfitting to any one of the plurality of tasks, using an end-to-end framework comprising a student-teacher model, a shared backbone, a classification task branch, a localization task branch, and a segmentation task branch, the framework integrating and concurrently performing the plurality of tasks on the plurality of image datasets, including cyclically training the learning model using the plurality of image datasets and sequentially processing each of the plurality of image datasets.

17. The system of claim 16, wherein sequentially processing each of the plurality of image datasets comprises:
extracting from the image dataset, by a student model of the end-to-end framework, relevant features for the respective tasks to be performed by the classification task branch, the localization task branch, and the segmentation task branch; and
sequentially directing the relevant features to one or more of the classification task branch, the localization task branch, and the segmentation task branch of the end-to-end framework.

18. The system of claim 17, wherein the relevant features for the tasks to be performed by the classification branch comprise high-level representations of images in the image dataset for classification, the method further comprising processing the high-level representations of images in the image dataset through a classification head of the classification task branch.

19. A non-transitory computer readable storage media having instructions stored thereupon that, when executed by a system having at least a processor and a memory therein, cause the processor to perform the following operations:
receiving a plurality of image datasets each including one or more of a plurality of inconsistent or heterogeneous annotations across a corresponding one or more of a plurality of tasks including classification, localization, and segmentation tasks employed in imaging; and
training, with the plurality of image datasets, the learning model to retain general knowledge across all of the plurality of tasks while preventing overfitting to any one of the plurality of tasks, using an end-to-end framework comprising a student-teacher model, a shared backbone, a classification task branch, a localization task branch, and a segmentation task branch, the framework integrating and concurrently performing the plurality of tasks on the plurality of image datasets, including implementing a lock-release pretraining strategy that involves cyclically training the learning model using the plurality of image datasets and sequentially processing each of the plurality of image datasets.

20. The non-transitory computer readable storage media of claim 19, wherein sequentially processing each of the plurality of image datasets comprises:
extracting from the image dataset, by a student model of the end-to-end framework, relevant features for the respective tasks to be performed by the classification task branch, the localization task branch, and the segmentation task branch; and
sequentially directing the relevant features to one or more of the classification task branch, the localization task branch, and the segmentation task branch of the end-to-end framework.
